(19) United States
(12) Patent Application Publication
(10) Pub. No.: US 2024/0118097 A1
(43) Pub. Date: Apr. 11, 2024

(54) DETERMINATION OF AN ITINERARY AS A FUNCTION OF THE QUALITY OF SERVICE OF A COMMUNICATION NETWORK

(71) Applicant: Orange, Issy-les-Moulineaux (FR)

(72) Inventors: Maroua Drissi, CHATILLON CEDEX (FR); Sylvain Allio, CHATILLON CEDEX (FR)

(21) Appl. No.: 18/478,074

(22) Filed: Sep. 29, 2023

(30) Foreign Application Priority Data
Sep. 30, 2022 (FR) 2210048

(51) Int. Cl. G01C 21/34; H04W 4/029; H04W 24/02

(52) U.S. Cl. CPC G01C 21/3461; G01C 21/343; H04W 4/029; H04W 24/02

(57) ABSTRACT

A method is described for determining an itinerary to be covered by a communicating object, as a function of the availability of a communication network on said itinerary. The method includes, at the object, based on points of departure and arrival of the itinerary, calculating first and second geographic positions associated respectively with the points of departure and of arrival, determining at least two itineraries between the positions, sending, to a device for predicting a communication network performance indicator, at least one geographic position of the object contained between the positions, for the two itineraries, receiving, from the device, in relation to the position, two predicted values of an indicator for, respectively, the at least two itineraries, and selecting the itinerary corresponding to the highest predicted value.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 2210048, filed Sep. 30, 2022, which is hereby incorporated by reference in its entirety.

### BACKGROUND

### Technical Field

The present application relates to the navigation techniques that allow a user to search for the itinerary that he or she must follow to reach a destination of his or her choice. More particularly, the present application relates to a method for determining an itinerary as a function of the quality of service of a communication network, and a corresponding device.

### Description of Related Technology

The navigation techniques, notably GPS (Global Positioning System), are these days very widely used. They are implemented in dedicated terminals which can for example be installed by the user in his or her vehicle or be incorporated as standard in the vehicle of the user. Such navigation techniques are also implemented in smartphones, which allows the user to move more easily, whether he or she is in a car, on foot, on a bicycle or even on public transport. To this end, such navigation techniques are implemented via native applications installed in these smartphones or via applications that can be downloaded previously. Some of these applications operate only with an Internet connection, for others this is not the case.

The most sophisticated current navigation techniques allow the user to determine an optimal itinerary following a selection by the user of various criteria, such as, for example, the distance, the duration of the journey, the state of the traffic, the cost, etc.

Moreover, these days, with the multiplicity of Internet uses and services and the quasi-permanent need for connectivity, the user who is moving over an itinerary needs to benefit from a certain quality of service of the communication network to which his or her smartphone, his or her navigation terminal or his or her vehicle is connected, in order to be able, for example, while moving over his or her itinerary, to listen to music online, use an automated driving application, for example V2X (vehicle-to-everything), download an application, a film, participate in a video conference, or other things. To meet such a need, certain current navigation techniques now take into account the network coverage in the search for the optimal itinerary over all or part of the itinerary.

However, despite the fact that the network coverage is taken into account, these navigation techniques do not make it possible to anticipate a change of quality of service, or QoS, relating to a connected service, usage or application required by the user, in a precise future position of the determined itinerary, and a future instant corresponding to this position. The network coverage is not, indeed, a sufficiently precise criterion to hope to satisfy the connectivity needs of the user on his or her itinerary. Although the determined itinerary proposes a network coverage that is sufficient over a portion of the journey, some performance indicators of this network, for example the latency and/or the reliability and/or the bitrate, etc., can change over time, for example as a function of the state of the communication network and of the road traffic situation, and, because of this, will perhaps not have the requisite level, necessary to the correct operation of the particular connected service, usage or application required by the user over this portion of the journey, the quality of service demands varying from one service, from one usage or from one application to the other.

Thus, even by taking account of the network coverage in the search for the optimal itinerary, the current itinerary determination methods lack precision and are not sufficiently dynamic, which is detrimental to the performance levels of the current navigation systems. Because of the lack of anticipation of the calculation of such performance indicators in the itinerary search, such itinerary determination methods are also not suited to certain motor vehicle applications such as remote-operated driving, autonomous driving and other such applications, risking endangering the safety of the users of autonomous or quasi-autonomous vehicles.

### SUMMARY

One of the aims of the disclosed technology is to remedy the drawbacks of the abovementioned prior art.

To this end, one subject of the disclosed technology relates to a method for determining an itinerary to be covered by a communicating object, as a function of the availability of a communication network on the itinerary, comprising the following, at the communicating object:
based on a point of departure and a point of arrival of the itinerary, calculating a first geographic position associated with the point of departure and a second geographic position associated with the point of arrival,
determining at least two itineraries between the first and second calculated geographic positions.

Such a method is characterized in that it implements the following:
sending, to a device for predicting at least one communication network performance indicator, at least one geographic position of the communicating object contained between the first and second geographic positions, for the at least two itineraries,
receiving, from the prediction device, in relation to said at least one geographic position, two predicted values of said at least indicator for, respectively, the at least two itineraries,
selecting, from among the at least two itineraries, the itinerary corresponding to the highest predicted value out of the two predicted values.

The disclosed technology advantageously makes it possible to select an itinerary which benefits from the best quality of service to meet the connectivity needs of the user of the communicating object over at least a portion of his or her journey on this itinerary which contains the future geographic position. Furthermore, the fact of predicting a performance indicator of a communication network available on the determined itinerary enhances the performance levels of the itinerary determination method, such a determination being implemented with a finer level of detail than those of the prior art because it is targeted on a particular performance indicator of the available communication network and not just on the presence or the type of a communication network. Furthermore, the benefit of predicting such a performance indicator makes it possible, throughout the itinerary on which the communicating object is moving, to adapt, dynamically and precisely and sufficiently upstream, to a change of quality of service of the communication network available on the determined itinerary, at at least one given future geographic position. In this way, on the duly determined itinerary, the communicating object is able to adjust its behaviour before the change of QoS takes effect at the future geographic position. Thus, the itinerary determination method according to the disclosed technology is suited to any type of communicating object, including the connected vehicles which implement certain motor vehicle applications such as remote-operated driving, autonomous driving and other such applications, which provides great safety for the user or users or passengers of connected vehicles.

According to a particular embodiment of the itinerary determination method, the method comprises:
a combination of the itinerary selection with another selection of one of the at least two itineraries which optimizes the application of at least one itinerary configuration parameter between the first and second geographic positions,
a selection, from among the at least two itineraries, of the itinerary which maximizes a criterion of optimization of the journey between the first and second geographic positions.

Such an embodiment makes it possible to determine an itinerary by taking account of several criteria which cannot be compared to one another, that is to say that are expressed in different units, without necessarily converting them into economic criteria, or into a single function. Indeed, a criterion such as the QoS is not comparable with an itinerary configuration parameter such as the distance of the journey and/or the duration of the journey and/or the traffic and/or the cost, etc. It does not involve searching for an optimum, but for a trade-off solution which can take various forms: choice, assignment or ranking.

According to a particular embodiment of the itinerary determination method, the combination implements:
a first weighting of the selection of the itinerary corresponding to the selected predicted value of said at least one performance indicator,
a second weighting of the selection of the itinerary optimizing the application of at least one itinerary configuration parameter.

Such an embodiment makes it possible, when determining the itinerary, to give greater importance to a criterion such as the QoS, the cost of the journey, the distance to be covered, etc., rather than another criterion, depending on the profile of the user of the communicating object.

According to a particular embodiment of the itinerary determination method, the at least one configuration parameter is an application or a communication service intended to be used between the first and second geographic positions.

Such an embodiment advantageously makes it possible to take account, as additional itinerary determination criterion, of an application or a communication service that the user wants to use during his or her journey. Such an application or communication service can for example be dedicated to a 4G voice communication, the downloading of a video, listening to streaming music, remote-operated driving, autonomous driving, etc.

According to a particular embodiment of the itinerary determination method, the application or the communication service can be selected or is implemented by default.

Such an embodiment allows the user to select, prior to the determination of an itinerary according to the disclosed technology, an application or a communication service that he or she wants to use during his or her journey, using a dedicated parameterizing implemented by the communicating object or using an interface connected to the communicating object. Alternatively, such a selection is implemented automatically, that is to say without the assistance of the user. Such an automatic selection occurs in the case for example where the communicating object is a connected vehicle, this connected vehicle notably comprising an emergency call application which is automatically selected.

According to a particular embodiment of the itinerary determination method, the selection of the application or of the communication service triggers the generation of at least one communication parameter or of at least one performance indicator of a communication network, the at least one communication parameter or the at least one performance indicator making it possible to maintain the operation of the application or of the communication service between the first and second geographic positions.

Such an embodiment advantageously makes it possible to precisely and automatically target the connectivity needs of the user for an application or a communication service selected by default or by the user, and to take account of such needs in the determination of the itinerary. If the user has for example selected an application which requires a network coverage of 5G type, the itinerary determination method according to the disclosed technology will take account only of the journeys covered by an available communication network of 5G type and will add the other criteria (distance, cost, time, etc.) to refine the search. According to another example, if a user has selected a streaming application, the itinerary determination method according to the disclosed technology will be demanding on a particular performance indicator, namely the bandwidth of the communication network available on the itinerary. According to yet another example, if a user uses a connected vehicle, he or she is not assumed to know the connectivity needs of the applications or communication services associated with the connected vehicle and possibly selected by this user. To this end, the itinerary determination method according to the disclosed technology will be able to deduce the performance indicator and/or indicators to be considered for these applications or services and a threshold value of each of these indicators.

According to a particular embodiment of the itinerary determination method, when the communicating object is moving on the itinerary which has been selected and an application or a communication service of the communicating object is used, the use is detected in the communication network covering the current geographic position of the communicating object, such that, when the communicating object approaches a future geographic position, for which a predicted value of at least one performance indicator has been calculated, and the predicted value does not observe a threshold value of the at least one performance indicator, making it possible to use the application or the communication service, at least one element of the communication network covering the future geographic position is adapted for the predicted value to observe the threshold value.

Such an embodiment advantageously makes it possible to implement, dynamically and upstream, on the selected itinerary and when an application or a communication service is used, an adaptation of the communication network, in order to improve the QoS at a future geographic position towards which the communicating object is moving, and do so without making any concession on the other possible criteria or configuration parameters of the itinerary which have been used to determine the itinerary.

The various embodiments or features mentioned above can be added, independently or in combination with one another, to the itinerary determination method defined above.

One subject of the disclosed technology relates also to a communicating object suitable for determining an itinerary to be covered by the communicating object, as a function of the availability of a communication network on the itinerary, the communicating object being configured to:
based on a point of departure and a point of arrival of said itinerary, calculate a first geographic position associated with the point of departure and a second geographic position associated with the point of arrival,
determine at least two itineraries between the first and second calculated geographic positions.

Such a communicating object is characterized in that it is also configured to:
send, to a device for predicting at least one performance indicator of a communication network available on the at least two itineraries, at least one geographic position of the communicating object contained between the first and second geographic positions, for the at least two itineraries,
receive, from the prediction device, in relation to the at least one geographic position, two predicted values of said at least indicator for, respectively, the at least two itineraries,
select, from among the at least two itineraries, the itinerary corresponding to the highest predicted value out of the two predicted values.

Such a communicating object is notably suitable for implementing the itinerary determination method according to any one of the embodiments described previously.

One subject of the disclosed technology relates also to a device for predicting at least one performance indicator of a communication network.

Such a prediction device is characterized in that it is configured to implement the following:
receive, from a communicating object, at least one geographic position belonging to at least two itineraries determined by the communicating object,
calculate, in relation to the at least one geographic position, two corresponding predicted values of said at least indicator for, respectively, the at least two itineraries,
send, to the communicating object, the two corresponding predicted values of said at least indicator.

One subject of the disclosed technology relates also to a system for determining an itinerary to be covered by a communicating object.

Such a system is characterized in that it comprises:
the communicating object implementing the abovementioned itinerary determination method,
the abovementioned prediction device.

The disclosed technology relates also to a computer program comprising instructions for implementing the method for determining an itinerary according to the disclosed technology, according to any one of the particular embodiments described previously, when this program is run by a processor.

Such instructions can be stored permanently in a non-transient memory medium of the communicating object and/or of a communication terminal and/or of a navigation device implementing the itinerary determination method according to the disclosed technology.

This program can use any programming language, and be in the form of source code, object code, or intermediate code between source code and object code, such as in a partially compiled form, or in any other desirable form.

The disclosed technology also targets a computer-readable storage medium or information medium, comprising instructions of a computer program as mentioned above.

The storage medium can be any entity or device capable of storing the program. For example, the medium can comprise a storage means, such as a ROM (Read Only Memory), for example a CD ROM (Compact Disc Read-Only Memory), synthetic DNA (deoxyribonucleic acid) or a microelectronic circuit ROM, or even a magnetic storage means, for example a mobile medium, a hard disk or an SSD (Solid State Drive).

Also, the storage medium can be a transmissible medium such as an electrical or optical signal, which can be conveyed via an electrical or optical cable, by radio or by other means, such that the computer program that it contains can be remotely executed. The program according to the disclosed technology can in particular be downloaded over a network, for example a network of Internet type.

Alternatively, the storage medium can be an integrated circuit in which the program is incorporated, the circuit being adapted to execute or to be used in the execution of the abovementioned itinerary determination method.

According to an exemplary embodiment, the present technique is implemented by means of software and/or hardware components. In this regard, the term “module” or “interface” can correspond in this document equally to a software component and to a hardware component or to a set of hardware and software components.

### BRIEF DESCRIPTION OF THE DRAWINGS

Other features and advantages will become apparent on reading particular embodiments of the disclosed technology, given as illustrative and nonlimiting examples, and the attached drawings.

FIG. 1 represents an itinerary determination system according to an embodiment of the disclosed technology.

FIG. 2 represents a communicating object in a particular embodiment of the disclosed technology.

FIG. 3 represents a device for predicting quality of service in a particular embodiment of the disclosed technology.

FIG. 4 represents the main actions implemented in the itinerary determination method, according to a particular embodiment of the disclosed technology.

FIG. 5 represents additional actions implemented in the itinerary determination method of FIG. 4, according to a particular embodiment of the disclosed technology.

FIG. 6 represents additional actions implemented in the itinerary determination method of FIG. 4, according to a particular embodiment of the disclosed technology.

FIG. 7 represents an example of application of the itinerary determination method, according to an embodiment of the disclosed technology.

### DETAILED DESCRIPTION

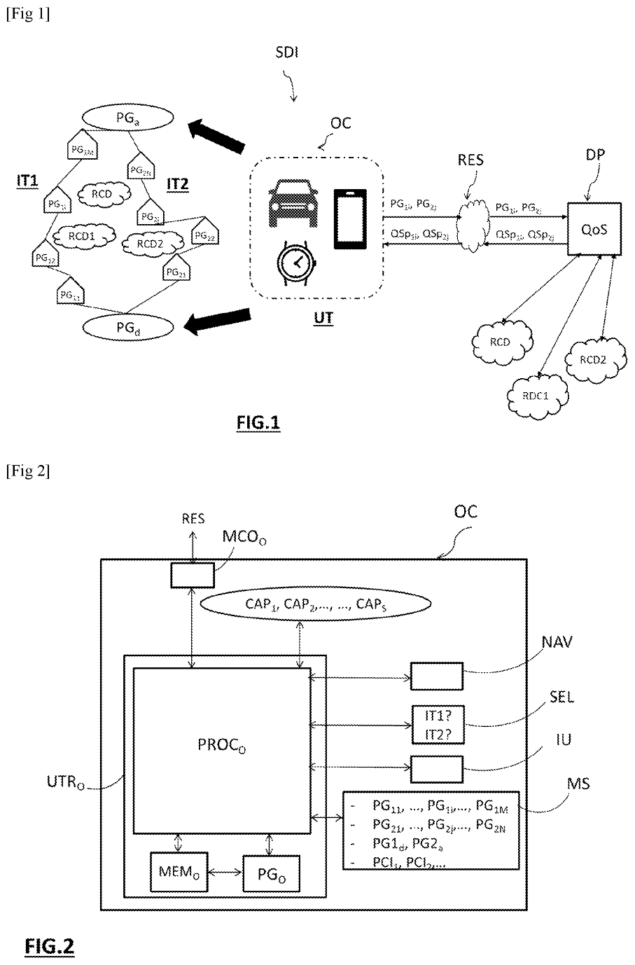

FIG. 1 represents an itinerary determination system, designated SDI, according to an embodiment of the disclosed technology.

Such a system comprises:
a connected or communicating object OC associated with a user UT,
a device for predicting quality of service QoS, designated DP, configured to communicate with the object OC, via a network RES, for example of IP and/or circuit type.

In the example of FIG. 1, the communicating object OC is for example a connected vehicle, here a car, a communication terminal of tablet or smartphone type, a connected watch, etc. To this end, the communicating object OC is provided natively with a plurality of sensors/detectors such as, for example, a camera and/or a speed sensor and/or a geolocation device of GPS type, etc.

The geolocation device of GPS type, integrated or interfaced with a geographic navigation device, allows the communicating object OC to determine what would be the most suitable itinerary according to at least one given criterion of choice, out of at least two possible itineraries IT1 and IT2, for the user UT of this object to go from a point of departure to a corresponding point of arrival respectively at first and second geographic positions, respectively PG_{d} and PGₐ, calculated by the geolocation device.

In accordance with the disclosed technology, one such at least one criterion of choice is the quality of service felt by the communicating object OC in a communication network available at a given geographic position of the itinerary IT1 and of the itinerary IT2.

As represented in FIG. 1:
the itinerary IT1 is defined by a plurality P1 of future geographic positions PG₁₁, PG₁₂, . . . , PG₁ᵢ, . . . , PG_{1M}, with M≥1, and 1≤i≤M, such a plurality P1 lying between the first and second geographic positions PG_{d} and PGₐ,
the itinerary IT2 is defined by a plurality P2 of future geographic positions PG₂₁, PG₂₂, . . . , PG₂ⱼ, . . . , PG_{2N}, with N≥1 and 1≤j≤N, such a plurality P2 lying between the first and second geographic positions PG_{d} and PGₐ.

M can be equal to or different from N. The itineraries IT1 and IT2 can contain, in common or not, at least one same future geographic position.

In the case where the itinerary determination is planned in advance, the geographic positions of departure PG_{d} and of arrival PGₐ are also considered as future geographic positions.

In the case where the itinerary determination is implemented at the moment when the user UT decides to move immediately over this itinerary using a communicating object OC, the geographic position of departure PG_{d} is considered as a current geographic position and the geographic position of arrival PGₐ is considered as a future geographic position.

Such an itinerary determination notably takes account of the presence of a communication network RCD available over all or part of the itineraries IT1 and IT2. Such a communication network can be the same for the two itineraries IT1 and IT2. It can be for example a 3G, 4G, 5G, WiFi, or other such network.

As an alternative, it can be two different communication networks: RCD1 for all or part of the itinerary IT1 and RCD2 for all or part of the itinerary IT2. In an exemplary embodiment, the network RCD1 is a 4G network and the network RCD2 is a 5G network.

In the itinerary determination system SDI according to the disclosed technology, the communicating object OC is configured to:
transmit, to the quality of service prediction device DP, via the network RES, at least one geographic position of the itinerary IT1, for example PG₁ᵢ, respectively at least one geographic position of the itinerary IT2, for example PG₂ⱼ,
receive, in return from the quality of service prediction device DP, predicted quality of service values QSp₁ᵢ and QSp₂ⱼ associated respectively with the two geographic positions PG₁ᵢ and PG₂ⱼ.

In the itinerary determination system SDI according to the disclosed technology, the quality of service prediction device DP is configured to, based on the geographic positions PG₁ᵢ, and PG₂ⱼ received from the communicating object OC:
determine predicted quality of service values QSp₁ᵢ and QSp₂ⱼ, that is to say values of at least one performance indicator representative of the quality of service for the communicating object OC, for each of the two geographic positions PG₁ᵢ and PG₂ⱼ received, in the available communication network RCD covering these two positions or in the available communication networks RCD1 and RCD2 respectively covering these two positions,
predict two respective values QSp₁ᵢ and QSp₂ⱼ of said at least one performance indicator, respectively for the two positions, based on past values of said at least one indicator which have been collected in the communication network RCD or in the communication networks RCD1 and RCD2.

According to the disclosed technology, a communication network performance indicator is for example the 3G, 4G, 5G, WiFi, etc. coverage type, the required minimum bitrate, the acceptable ratio or number of packets lost, the maximum admissible packet latency, etc. The measurement of such an indicator thus makes it possible to assess, for a given communication network, whether or not the requirements in terms of quality of service are met.

### Description of an Embodiment of the Communicating Object OC

FIG. 2 presents the simplified structure of the communicating object OC which is suitable for implementing the itinerary determination method which will be described hereinbelow.

To this end, such a communicating object OC comprises:
one or more sensors/detectors CAP₁, CAP₂, . . . , CAP_{S} (S≥1), such as, for example, a camera, a sensor which detects the level of charge of the battery if the communicating object OC is a vehicle, a speed sensor, a geolocation device of GPS (Global Positioning System) type, a fingerprint sensor, etc.
a navigation module NAV of GPS type configured to determine an itinerary to be followed by the user UT of the communicating object OC,
a module SEL for selecting an itinerary from among the at least two itineraries IT1, IT2,
a user interface IU conventionally comprising a keyboard (physical or digital), possibly a microphone and/or a loudspeaker,
a communication module or interface MCOₒ which is configured to communicate via, for example, the cellular radiotelephony (5G for example), IP, circuit, etc. technologies, with the quality of service prediction device DP,
a storage memory MS for temporarily storing the geographic positions of departure PG_{d} and of arrival PGₐ of the itineraries IT1 and IT2, the pluralities P1, P2 of geographic positions, and, if necessary, one or more configuration parameters PCI₁, PCI₂, . . . , of the itinerary to be optimized, such as, for example, the distance of the journey and/or the duration of the journey and/or the traffic and/or the cost of the journey (fuel, toll, etc.) and/or even an application or a particular communication service that the user UT wants to use on the itinerary or that the communicating object OC selects by default, etc.

The data representative of a geographic map intended to contain the itineraries IT1 and IT2 can also be stored in the memory MS or another dedicated memory. Such a geographic map is intended to be displayed in its entirety or by portions on the screen of the user interface IU. As an alternative, such a map is broadcast by sound via the loudspeaker or speakers of the user interface IU.

In the case where the communicating object OC is a connected vehicle, the navigation module NAV can already be incorporated in the vehicle, as a first-fit element, or be an independent device, of the type of those which are available on the market, and thus be connected to the vehicle using a wired or wireless link.

In the case where the communicating object OC is for example a smartphone, a portable personal computer, a connected watch, etc., the navigation module NAV can be a native application or one that has been downloaded previously into the communicating object OC.

As a variant, the memory MS can be remote in a communication network, a cloud, etc. and be made accessible by the communicating object OC, by means of the communication module MCOₒ or of a communication module (not represented) dedicated to that purpose.

According to a particular embodiment of the disclosed technology, the actions executed by the communicating object OC, in the context of the implementation of the itinerary determination method according to the disclosed technology, are implemented by instructions of a computer program PGₒ. For that, the communicating object OC has the conventional architecture of a computer and notably comprises a memory MEMₒ, a processing unit UTRₒ, equipped for example with a processor PROCₒ, and driven by the computer program PGₒ stored in memory MEMₒ. The computer program PGₒ comprises instructions for implementing the actions executed by the communicating object OC, when the program is run by the processor PROCₒ, according to any one of the particular embodiments of the disclosed technology.

On initialization, the code instructions of the computer program PGₒ are for example loaded into a RAM memory (not represented) before being executed by the processor PROCₒ. The processor PROCₒ of the processing unit UTRₒ notably implements, according to the instructions of the computer program PGₒ, the actions of determination of points of departure PG_{d} and of arrival PGₐ, for at least the itineraries IT1 and IT2, actions of collection of the data from the sensor and/or sensors CAP₁, CAP₂, . . . , CAP_{S}, notably the GPS data from the communicating object OC, navigation actions of GPS type, actions of calculation of the plurality P1 and P2 of geographic positions contained between the geographic positions associated respectively with the points of departure PG_{d} and of arrival PGₐ, actions of communication with the prediction device DP, and itinerary selection actions.

### Description of an Embodiment of the Performance Indicator Prediction Device DP

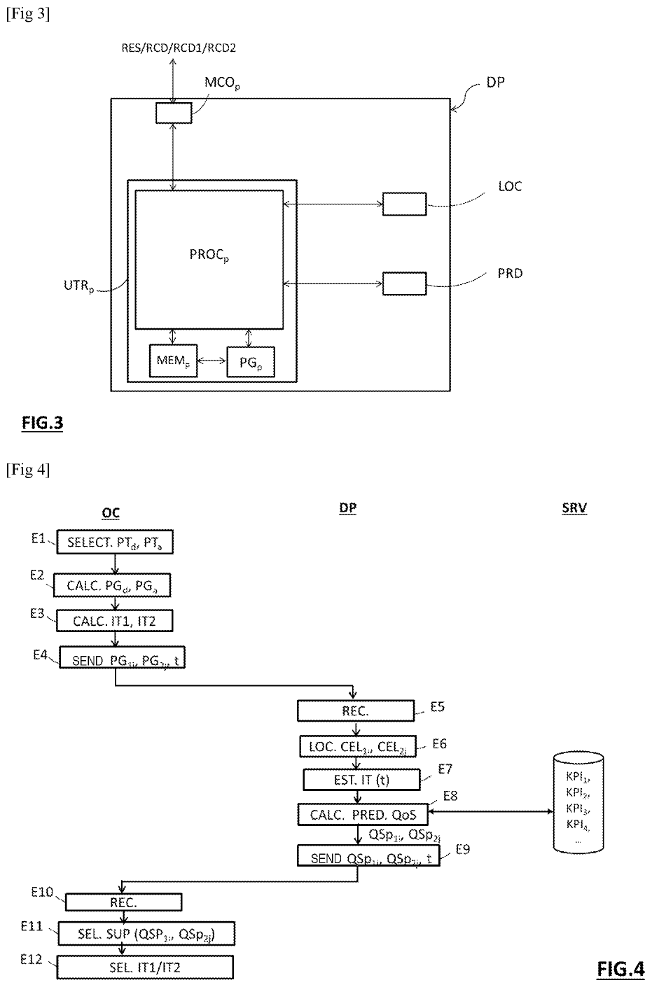

FIG. 3 presents the simplified structure of the device DP for predicting at least one performance indicator, the device DP being adapted to implement certain actions of the itinerary determination method which will be described hereinbelow.

To this end, such a prediction device DP comprises:
a communication module or interface MCOₚ which is configured to communicate, via, for example, the cellular radiotelephony (5G for example), IP, circuit, etc. technologies, with the communicating object OC, said module MCOₚ being notably configured to:
   receive, from the communicating object OC, via the network RES of FIG. 1, all or part of the geographic positions of each of the at least two itineraries IT1 and IT2,
   send, to the communicating object OC, predicted values of at least one performance indicator, in association with the geographic positions of each of the at least two itineraries IT1 and IT2 which have been received,
a location module LOC configured to locate at least one cell of a communication network covering a geographic position corresponding to at least one geographic position of the itinerary IT1, for example the geographic position PG₁ᵢ, and a geographic position corresponding to at least one geographic position of the itinerary IT2, for example the geographic position PG₂ⱼ,
a prediction module PRD configured to predict at least one performance indicator of the communication network covering the geographic position corresponding for example to the geographic position PG₁ᵢ of the itinerary IT1 and of the communication network covering the geographic position corresponding for example to the geographic position PG₂ⱼ of the itinerary IT2.

According to a particular embodiment of the disclosed technology, the actions executed by the prediction device DP, in the context of the implementation of the itinerary determination method according to the disclosed technology, are implemented by instructions of a computer program PGₚ. For that the prediction device DP has the conventional architecture of a computer and notably comprises a memory MEMₚ, a processing unit UTRₚ, equipped for example with a processor PROCₚ, and driven by the computer program PGₚ stored in memory MEMₚ. The computer program PGₚ comprises instructions for implementing the actions executed by the prediction device DP, when the program is run by the processor PROCₚ, according to any one of the particular embodiments of the disclosed technology.

On initialization, the code instructions of the computer program PGₚ are for example loaded into a RAM memory (not represented) before being executed by the processor PROCₚ. The processor PROCₚ of the processing unit UTRₚ notably implements, according to the instructions of the computer program PGₚ, the actions of communication with the communicating object OC, or with a management server of the network RCD or of the networks RCD1, RCD2, the actions of location and of prediction cited above.

The prediction device DP can be located directly in a network infrastructure, for example a base station controller, a base station, a router, etc.

Alternatively, this prediction device DP can be located for example in an application management server of the network of the operator, in an operational subsystem, etc.

### Description of an Embodiment of an Itinerary Determination Method

The main steps of the itinerary determination method implemented in the itinerary determination system of FIG. 1 are now described, in relation to FIG. 4.

During a step E1, once the user UT has activated the navigation module NAV via the user interface IU, a selection of a point of departure PT_{d} and of a point of arrival PTₐ is implemented. The points of departure PT_{d} and of arrival PTₐ comprise, for example, a town, a precise address of a town, a monument, etc.

In a step E2, the navigation module NAV calculates a first geographic position PG_{d} associated with the point of departure PT_{d} and a second geographic position PGₐ associated with the point of arrival PTₐ.

The selection E1 of the points of departure PT_{d} and of arrival PTₐ can be performed at the initiative of the user UT using the interface IU of the communicating object OC.

The selection of the point of departure PT_{d} can also be performed automatically by the communicating object OC based on a geolocation of this object which is implemented by the geolocation device GPS of the communicating object OC. The selection E1 of the point of departure PT_{d} and the calculation of its associated geographic position PG_{d} thereby form part of one and the same step.

In a step E3, at least two possible itineraries IT1 and IT2 are determined between the geographic positions PG_{d} and PGₐ using the navigation module NAV.

Such a determination is conventional and is implemented using a dedicated computation algorithm.

The itinerary IT1 comprises the following geographic positions which follow one another in time:
PG_{d}, PG₁₁, PG₁₂, . . . , PG₁ᵢ, . . . , PG_{1M}, PGₐ.

The itinerary IT2 comprises the following geographic positions which follow one another in time:
PG_{d}, PG₂₁, PG₂₂, . . . , PG₂ⱼ, . . . , PG_{2N}, PGₐ.

The itineraries IT1 and IT2 can be displayed on the screen of the user interface IU.

In the context of the disclosed technology, it is considered that the user UT needs connectivity over the proposed itineraries IT1 and IT2.

Such connectivity needs are linked to the fact that, during the journey of the user UT over the itinerary to be determined, the user, by way of non-exhaustive and nonlimiting examples:
must participate in a videoconference,
wants to listening to streaming music,
and, in the particular case where the communicating object OC is a connected vehicle, wants to activate/use certain dedicated applications, for example of V2X type, such as driving in a platoon, cooperative driving, remote driving, etc.

Each of the abovementioned connectivity needs involves particular demands in terms of quality of service which depends on the performance levels of the communication network in which the communicating object OC is located at a given moment. Such demands are measurable using one or more network performance indicators, called KPI (Key Performance Indicator), such as, for example:
the latency KPI₁ expressed in ms,
the packet loss ratio or reliability KPI₂ expressed as %,
the bitrate KPI₃ expressed in Mbps,
the type of network coverage KPI₄: 2G, 3G, 4G, 5G, WiFi, etc.,
etc.

Regarding a videoconference, the performance indicator and/or indicators to be taken into account are notably the bitrate and the latency, and in the case where the communicating object OC is a connected vehicle, the type of network coverage which is 5G.

Regarding listening to streaming music, the performance indicator and/or indicators to be taken into account is notably the bitrate.

Concerning V2X applications, the table T1 below summarizes these demands for the applications such as, for example, driving in a platoon, cooperative driving, remote driving.

TABLE T1

| | End- | | | |
|---|---|---|---|---|
| | to-end | | | |
| | latency | Reliability | Bitrate | Coverage |
| Application | (ms) | (%) | (Mbps) | type |
| Platoon | 10 | 99.99 | 50-65 | 4G/5G |
| Cooperative | 3-10 | 99.99 | 30-53 | 5G |
| driving | | | | |
| Remote | 5 | 99.99 | 1-25 | 5G |
| driving | | | | |

In a step E4:
at least one geographic position of the itinerary IT1, for example the position PG₁ᵢ, is sent to the prediction device DP via the network RES, via the communication module MCOₒ of the communicating object OC,
at least one geographic position of the itinerary IT2, for example the position PG₂ⱼ, is sent to the prediction device PRED via the network RES, via the communication module MCOₒ, of the communicating object OC.

As is known per se, such geographic positions PG₁ᵢ and PG₂ⱼ are associated respectively with an instant t which has been estimated by the navigation module NAV, this instant t corresponding to the arrival of the communicating object OC at these two positions PG₁ᵢ and PG₂ⱼ, on the itineraries IT1 and IT2 respectively.

In the case where the communicating object OC is moving at a certain speed, the value of this speed is also communicated in E4 to the prediction device DP.

All or part of the geographic positions, as well as their associated instants, on each of the itineraries IT1 and IT2, can be sent to the prediction device DP.

In a step E5, the prediction device DP receives the positions PG₁ᵢ and PG₂ⱼ, via its communication module MCOₚ, and the corresponding instant t.

In a step E6, the prediction device DP implements a location, via its location module LOC:
of a cell CEL₁ᵢ of the communication network RCD or RCD1 which covers the position PG₁ᵢ,
and of a cell CEL₂ⱼ of the communication network RCD or RCD2 which covers the position PG₂ⱼ.

In the case of the network RCD common to the two itineraries IT1, IT2, the cell CEL₁ᵢ can be the same as the cell CEL₂ⱼ or be a different cell.

The location E6 can be implemented by the prediction device DP. In an alternative embodiment, the prediction device DP can be configured to request, from a communication network management system, an identification of the cells CEL₁ᵢ and CEL₂ⱼ based on the positions PG₁ᵢ and PG₂ⱼ and on the instant t which were received in E4.

In a step E7, the prediction device DP estimates a time slot IT which contains the instant t.

In a step E8, in the estimated time slot IT, the prediction device DP calculates, via its prediction module PRD (FIG. 3):
a predicted value QSp₁ᵢ of one or more of the abovementioned performance indicators KPI₁, KPI₂, KPI₃, KPI₄, etc., in relation to the position PG₁ᵢ,
a predicted value QSp₂ⱼ of one or more of the abovementioned performance indicators KPI₁, KPI₂, KPI₃, KPI₄, etc., in relation to the position PG₂ⱼ.

The values of the performance indicators KPI₁, KPI₂, KPI₃, KPI₄, etc. are measured in a management server SRV of the network RCD, or of the networks RCD1 and RCD2.

Said prediction E8 is at least of time-related type. To this end, the predicted values QSp₁ᵢ, QSp₂ⱼ for a given performance indicator, for example KPI₁, are predicted on the basis of values of the indicator KPI₁ already obtained at instants preceding the time slot IT, for each of the cells CEL₁ᵢ and CEL₂ⱼ.

In order to refine this prediction, said prediction E8 can further be spatial, that is to say that:
the predicted value QSp₁ᵢ is obtained by also taking account of an estimation, in the time slot IT, of the position of the communicating object OC in the network coverage of a base station belonging to the network RCD or to the network RCD1,
the predicted value QSp₂ⱼ is obtained by also taking account of an estimation, in the time slot IT, of the position of the communicating object OC in the network coverage of a base station belonging to the network RCD or to the network RCD2.

Such a prediction is for example described in the document FR2113319.

In a step E9, the prediction device DP sends, to the communicating object OC, via the network RES, the predicted values QSp₁ᵢ and QSp₂ⱼ, via the communication module MCOₚ.

In E10, the communicating object OC receives the predicted values QSp₁ᵢ and QSp₂ⱼ via its communication module MCOₒ.

In a step E11, the selection module SEL of the communicating object OC selects the highest predicted value from among the predicted values QSp₁ᵢ and QSp₂ⱼ.

In a step E12, the selection module SEL of the communicating object OC selects, from among the alternative itineraries IT1, IT2, that which corresponds to the highest predicted value which was selected in E11. If it is the predicted value QSp₁ᵢ which is the highest, the itinerary IT1 is selected as having the best quality of service at the position PG₁ᵢ. If it is the predicted value QSp₂ⱼ which is the highest, the itinerary IT2 is selected as having the best quality of service at the position PG₂ⱼ.

The itinerary determination method which has just been described above is updated as the communicating object OC moves over the selected itinerary.

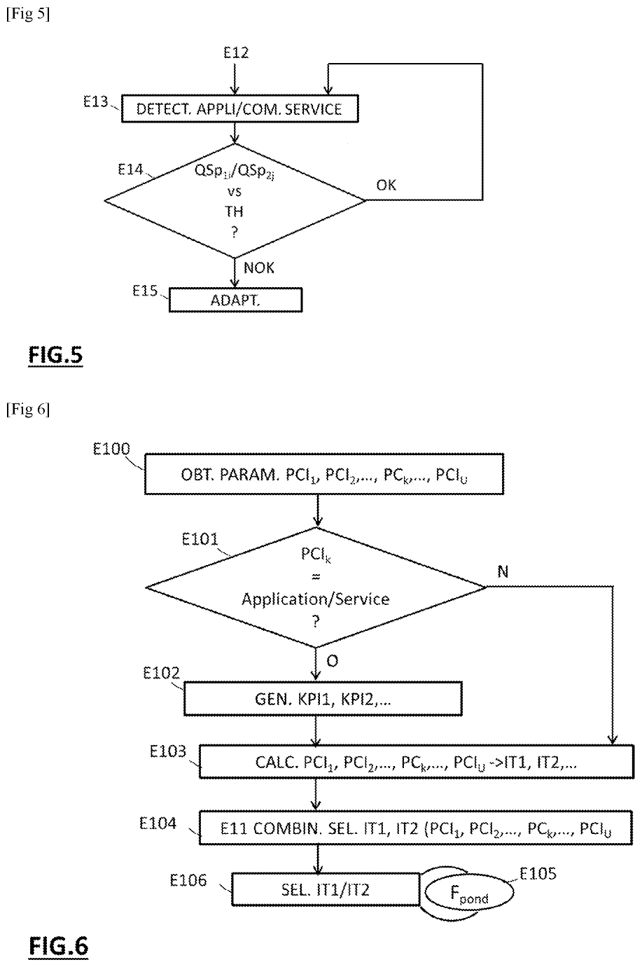

In an embodiment of the disclosed technology represented in FIG. 5, when the communicating object OC is moving over the itinerary selected in E12 and an application or a communication service is activated or used, the network management server SRV detects this activation or usage in E13.

In a step E14, the performance indicator value, QSp₁ᵢ or QSp₂ⱼ depending on the itinerary selected, which has been predicted in association with a future position to which the communicating object OC is directed, is compared by the server SRV to a threshold value TH that makes it possible to correctly use the application or the communication service.

If the performance indicator value QSp₁ᵢ or QSp₂ⱼ does not comply with (NOK) the threshold value TH, at least one element of the communication network RCD or RCD1/RCD2 which covers this future position is adapted in E15 for the predicted performance indicator value QSp₁ᵢ or QSp₂ⱼ to comply with this threshold value TH.

This case occurs when the user UT uses, for example, a videoconferencing application, for which the bitrate must be greater than a value TH=20 Mbs. If the predicted value of the bitrate at this future position is lower than 20 Mbs, an adaptation of at least one network element will be implemented in the communication network concerned, so as to increase the bitrate above the value TH when the object OC is approaching its future position.

In another non-exhaustive example, this case can also occur when the user UT uses, for example, a remote driving application, for which the latency must be less than a value TH=5 ms. If the predicted value of the latency at this future position is greater than 5 ms, an adaptation of at least one network element will be implemented in the communication network concerned, so as to reduce the latency below the value TH as the object OC approaches its future position.

Such an adaptation can be manual or remotely driven by the server SRV. It can involve a modification of a parameterizing of an antenna in the cell of the communication network concerned, a rebalancing of the handover thresholds, etc.

If the predicted performance indicator value QSp₁ᵢ or QSp₂ⱼ complies with (OK) the threshold value TH, the server SRV reverts to the step E12 pending detection of a use/activation of an application or of a communication service.

The adaptation which has just been described makes it possible to render the itinerary determination method particularly flexible and proactive, while addressing the connectivity needs of the user UT in a targeted manner.

In an embodiment of the disclosed technology represented in FIG. 6, the itinerary determination method which has just been described above takes account of at least one itinerary configuration parameter PCIₖ out of a plurality of possible itinerary configuration parameters PCI₁, PCI₂, . . . , PCIₖ, . . . , PCI_{U}, with 1≤k≤U.

To this end, in a step E100, one or more configuration parameters are obtained.

In a non-exhaustive manner, such configuration parameters comprise:
a distance to be covered between the geographic positions of departure PG_{d} and of arrival PGₐ, for each of the itineraries IT1, IT2, and/or
a time to cover each of the itineraries IT1, IT2 between the geographic positions of departure PG_{d} and of arrival PGₐ, and/or
a cost to cover each of the itineraries IT1, IT2 between the geographic positions of departure PG_{d} and of arrival PGₐ, for example from the point of view of fuel, toll, inspection sticker, etc., and/or
roads to be avoided, for example motorways rather than national roads, hazardous crossroads, unsurfaced roads, etc., and/or
a service or a communication application that the user UT wants to use during his or her journey over the itinerary, such as, for example, a videoconferencing application, a music streaming service, a remote driving application, etc.,
etc.

Such configuration parameters can be selected manually or orally by the user UT using the interface IU of the communicating object OC or any user interface connected to this object.

Such configuration parameters can also be generated automatically. Indeed, in the case where the communicating object OC is a connected vehicle, an emergency call application is activated automatically without the user UT needing to make any particular selection. In another example, following an identification by the communicating object OC of the user UT, such as, for example, an identification by passwords or biometrics, one or more configuration parameters previously associated with this identification can be selected after the communicating object OC has confirmed the identification of the user UT.

In a step E101, for at least one itinerary configuration parameter PCIₖ, if this parameter is an application or a communication service, one or more communication network performance indicators are generated in E102, in order to be used for the prediction. Otherwise, the itinerary determination method goes on to a next step E103.

For example, if a videoconferencing application is selected as itinerary configuration parameter, the communicating object OC generates the following performance indicator and/or indicators:
latency KPI₁ (ms)<5,
bitrate KPI₃ (Mbps)≤10,
network coverage type KPI₄: 5G if the communicating object OC is a connected vehicle.

In another example, if a remote driving application is selected as itinerary configuration parameter, the communicating object OC generates the following performance indicator and/or indicators:
latency KPI₁ (ms)<5,
reliability KPI₂ (%)≥99.99,
bitrate KPI₃ (Mbps)≤25,
network coverage type KPI₄: 5G.

In the step E103, for each of the at least two itineraries IT1 and IT2, the following are calculated according to the configuration parameter or parameters obtained:
the distance to be covered for each itinerary IT1, IT2, and/or
the cost for each itinerary IT1, IT2, and/or
the time to cover each itinerary IT1, IT2, and/or
etc.

In the case where the cost for each itinerary IT1, IT2 is calculated, the cost of the fuel consumed for each itinerary IT1, IT2 is calculated on the basis of the consumption information of the connected vehicle OC, as is the cost of the toll or tolls if there are any, etc.

In the case where the time to cover each itinerary IT1, IT2 is calculated, the state of the road traffic can be taken into account.

In a step E104, the selection E11 of the itinerary illustrated in FIG. 4 is combined with an itinerary selection taking account of at least one of the abovementioned itinerary configuration parameters PCI₁, PCI₂, . . . , PCIₖ, . . . , PCI_{U}.

To this end, a matrix MA of the alternatives is calculated as follows for a plurality of itineraries IT1, IT2, . . . , ITn, with n≥1:

$$MA = ( \begin{matrix}{x}_{1 , 1} & {x}_{1 , 2} & … & {x}_{1 , V} \\ ⋮ & ⋮ & ⋱ & ⋮ \\ {x}_{n , 1} & {x}_{n , 2} & … & {x}_{n , V}\end{matrix} ) \qquad [ equation 1 ]$$

The matrix of the alternatives MA is a multicriteria decision matrix which comprises:
one row for each of the n itineraries,
at least one column containing n predicted values of at least one network performance indicator KPI₁, KPI₂, . . . , for, respectively, the n itineraries,
and at least one other column containing n values of at least one itinerary configuration parameter out of the parameters PCI₁, PCI₂, . . . , PCIₖ, . . . , PCI_{U} for, respectively, the n itineraries.

In the example represented, the matrix MA is considered to be based on V criteria X₁ to X_{V} representative of one or more performance indicators and of one or more itinerary configuration parameters.

The matrix MA is applied for at least two itineraries, with n≥2.

In the example represented:
if, for example, the first column of values is assigned to a network performance indicator, x_{1,1}, . . . , x_{n,1} represent the predicted values of the network performance indicator considered for, respectively, the n itineraries;
if, for example, the second column of values is assigned to the cost of the itinerary, X_{1,2}, . . . , x_{n,2} represent the values of this cost for, respectively, the n itineraries;
if, for example, the last column of values is assigned to the distance of the itinerary, x_{1,V}, . . . , x_{n,V} represent the values of this distance for, respectively, the n itineraries.

Advantageously, the multicriteria decision matrix MA thus offers itself as an alternative to the conventional decision methods based on the definition of a single function. It takes account of several criteria X₁ to X_{V} which are not mutually comparable. Indeed, the “quality of service prediction” criterion is not of the same kind as the “distance”, “cost”, or other such criterion.

The benefit of the matrix MA is thus to consider a set of criteria of different kinds (expressed in different units), without necessarily transforming them into economic criteria, or into a single function. The aim is not to search for an optimum, but for a trade-off solution between one or more network parameters and one or more road parameters, such a trade-off being able to take various forms: choice, assignment or ranking.

A criterion of optimization of the journey between the geographic positions of departure and of arrival is applied during a step E105.

In one embodiment, this optimization criterion is a weighting function F_{pond} which is applied to the abovementioned criteria of different kinds.

Such a weighting function is for example a weighted sum which is known by its mathematical accessibility. It involves calculating, for each row 1 of the matrix MA, the normalized and weighted sum of the criteria X₁ to X_{V}, as follows:

F_{pond}=Σ_{c=1}^{c=V}w_{c}·X_{c} with 1≤l≤n and Σ₁^{V}|w_{c}|=1 [equation 2]

The weight w_{c} defines the importance of the criterion X_{c}. If the criteria have the same level of importance, then X_{c}=1/V.

When w_{c}<0 is applied to a criterion, this criterion is minimized.

The value of the weights is based on the preferences of the user UT, selected using the interface IU of the communicating object OC or any interface connected to this object.

The application of such a weighting function F_{pond} to the criteria X₁ to X_{V} is thus particularly suited to the decision-making problems when a large volume of information is considered and the selection of a solution (here an itinerary) is performed at multiple levels.

In a step E106, one of the n itineraries is selected following the application of the weighting function F_{pond}.

### Description of an Example of Application of the Itinerary Determination Method

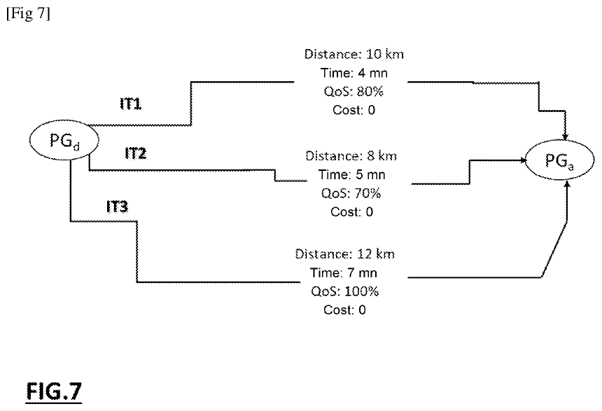

Referring to FIG. 7, an example of application of the itinerary determination method according to the disclosed technology is now described.

In the example of FIG. 7, it is considered that three itineraries IT1, IT2, IT3 have been determined at the end of the step E3 of FIG. 4.

The matrix MA is based in this example on four criteria X₁, X₂, X₃, X₄ which are:
X₁=the distance,
X₂=the time,
X₃=the predicted QoS,
X₄=the cost.

The criterion X₃ takes the predicted value of the bitrate and/or of the latency and/or of the reliability, etc.

The values of these criteria are different for each of three itineraries, apart from the cost of the journey which is nil.

The matrix MA is then written as follows:

$$MA = ( \begin{matrix}10 & 4 & 80 & 0 \\ 8 & 5 & 70 & 0 \\ 12 & 7 & 100 & 0\end{matrix} ) \qquad [ equation 3 ]$$

The normalized matrix MA is then written as follows:

$${MA}_{n o r m} = ( \begin{matrix}0.06 & 0.02 & 0.54 & 0 \\ 0.05 & 0.03 & 0.47 & 0 \\ 0.08 & 0.04 & 0.67 & 0\end{matrix} ) \qquad [ equation 4 ]$$

In this example, it is assumed that there are two different user profiles.

According to the first profile, the user UT wants to arrive as quickly as possible without worrying about the cost or the availability of the communication network covering his or her journey.

To this end, the user assigns the following weights w_{c} to the abovementioned four criteria.
w₁=−0.3,
w₂=−0.5,
w₃=0.1,
w₄=−0.1.

In the step E105 of FIG. 6, the weighting function F_{pond} is applied as follows:

$${F}_{pond} = max ( \begin{matrix}0.06 \times - 0.3 & 0.02 \times - 0.5 & 0.54 \times 0.1 & 0 \times - 0.1 \\ 0.05 \times - 0.3 & 0.03 \times - 0.5 & 0.47 \times 0.1 & 0 \times - 0.1 \\ 0.08 \times - 0.3 & 0.04 \times - 0.5 & 0.67 \times 0.1 & 0 \times - 0.1\end{matrix} ) \qquad [ equation 5 ]$$

$${F}_{pond} = max ( \begin{matrix}0.026 \\ 0.017 \\ 0.023\end{matrix} ) \qquad [ equation 6 ]$$

The itinerary selected for this profile in the step E106 of FIG. 6 is then the itinerary IT1.

According to the second profile, the user UT wants to use an automated driving application, which means that permanent and good quality network coverage needs to be present over his or her journey.

To this end, the user assigns the following weights w_{c} to the abovementioned four criteria.
w₁=−0.2,
w₂=−0.2,
w₃=0.4,
w₄=−0.2.

In the step E105 of FIG. 6, the weighting function F_{pond} is applied as follows:

$$F = max ( \begin{matrix}0.06 \times - 0.2 & 0.02 \times - 0.2 & 0.54 \times 0.4 & 0 \times - 0.2 \\ 0.05 \times - 0.2 & 0.03 \times - 0.2 & 0.47 \times 0.4 & 0 \times - 0.2 \\ 0.08 \times - 0.2 & 0.04 \times - 0.2 & 0.67 \times 0.4 & 0 \times - 0.2\end{matrix} ) \qquad [ equation 7 ]$$

$$F = max ( \begin{matrix}0.02 0 \\ 0.172 \\ 0.244\end{matrix} ) \qquad [ equation 8 ]$$

The itinerary selected for this profile in the step E106 of FIG. 6 is then the itinerary IT3.

What is claimed is:

1. A method for determining an itinerary to be covered by a communicating object as a function of the availability of a communication network on said itinerary, the method comprising, at said communicating object:
from a point of departure and a point of arrival of said itinerary, calculating a first geographic position associated with the point of departure and a second geographic position associated with the point of arrival,
determining at least two itineraries between the first and second calculated geographic positions,
sending, to a device for predicting at least one communication network performance indicator, at least one geographic position of the communicating object contained between the first and second geographic positions, for said at least two itineraries,
receiving, from the prediction device, in relation to said at least one geographic position, two predicated values of said at least indicator for, respectively, said at least two itineraries, and
selecting, from among the at least two itineraries, the itinerary corresponding to the highest predicted value out of the two predicted values.

2. The method of claim 1, further comprising:
a combination of said itinerary selection with another selection of one of the at least two itineraries which optimizes the application of at least one itinerary configuration parameter between the first and second geographic positions,
selecting, from among the at least two itineraries, of the itinerary which maximizes a criterion of optimization of the journey between the first and second geographic positions.

3. The method of claim 2, wherein the combination implements:
a first weighting of the selection of the itinerary corresponding to the selected predicted value of said at least one performance indicator,
a second weighting of the selection of the itinerary optimizing the application of at least one itinerary configuration parameter.

4. The method of claim 2, wherein said at least one configuration parameter is an application or a communication service intended to be used between the first and second geographic positions.

5. The method of claim 4, wherein the application or the communication service can be selected or is implemented by default.

6. The method of claim 4, wherein the selection of the application or of the communication service triggers the generation of at least one communication parameter or of at least one performance indicator of a communication network, said at least one communication parameter or said at least one performance indicator making it possible to maintain the operation of the application or of the communication service between the first and second geographic positions.

7. The method of claim 1, wherein, when the communicating object is moving over the itinerary which has been selected and an application or a communication service of said communicating object is used, said use is detected in the communication network covering the current geographic position of the communicating object, such that when the communicating object approaches a future geographic position, for which a predicted value of at least one performance indicator has been calculated, and said predicted value does not observe a threshold value of said at least one performance indicator, making it possible to use the application or the communication service, at least one element of the communication network covering the future geographic position is adapted for the predicted value to observe said threshold value.

8. A communicating object adapted to determine an itinerary to be covered by said communicating object, as a function of the availability of a communication network on said itinerary, said communicating object being configured to:
based on a point of departure and a point of arrival of said itinerary, calculate a first geographic position associated with the point of departure and a second geographic position associated with the point of arrival,
determine at least two itineraries between the first and second calculated geographic positions,
send, to a device for predicting at least one performance indicator of a communication network available on the at least two itineraries, at least one geographic position of the communicating object contained between the first and second geographic positions, for said at least two itineraries,
receive, from the prediction device, in relation to said at least one geographic position, two predicted values of said at least indicator for, respectively, said at least two itineraries, and
select, from among the at least two itineraries, the itinerary corresponding to the highest predicted value out of the two predicted values.

9. A device for predicting at least one performance indicator of a communication network, characterized in that said device is configured to implement the following:
receive, from a communicating object, at least one geographic position belonging to at least two itineraries determined by said communicating object,
calculate, in relation to said at least one geographic position, two corresponding predicted values of said at least indicator for, respectively, said at least two itineraries, and
send, to the communicating object, the two corresponding predicted values of said at least indicator.

10. A system for determining an itinerary to be covered by a communicating object, the system comprising:
a communicating object configured to:
based on a point of departure and a point of arrival of said itinerary, calculate a first geographic position associated with the point of departure and a second geographic position associated with the point of arrival,
determine at least two itineraries between the first and second calculated geographic positions,
send, to a device for predicting at least one performance indicator of a communication network available on the at least two itineraries, at least one geographic position of the communicating object contained between the first and second geographic positions, for said at least two itineraries,
receive, from the prediction device, in relation to said at least one geographic position, two predicted values of said at least indicator for, respectively, said at least two itineraries, and
select, from among the at least two itineraries, the itinerary corresponding to the highest predicted value out of the two predicted values, and
the prediction device of claim 9.

11. A non-transitory, computer readable medium having stored thereon instructions which, when executed by a processor, cause the processor to implement the method of claim 1.

12. A computer comprising a processor and a memory, the memory having stored thereon instructions which, when executed by the processor, cause the computer to implement the method of claim 1.
